(19) United States
(12) Patent Application Publication
(10) Pub. No.: US 2006/0239863 A1
(43) Pub. Date: Oct. 26, 2006

(54) Line element for handling fluids

(75) Inventors: Hannes Zach, Marein (AT); Markus Lafer, Herrmannsdorf (AT); Peter Kettisch, Graz (AT); Rainer Zentner, Graz (AT)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Anton Paar GmbH

(21) Appl. No.: 11/406,752

(22) Filed: Apr. 19, 2006

(30) Foreign Application Priority Data
Apr. 20, 2005 (DE) DE102005018352.2

(51) Int. Cl. B01L 3/00

(52) U.S. Cl. 422/100

(57) ABSTRACT

The invention relates to a line element for handling fluids, in particular for digestion or for synthesis of substances in chemical process engineering, said line element comprising at least one temperature-resistant and pressure-resistant support element (15) that has a first interior in which an inner line (14) made of a plastic material resistant to chemicals is arranged, at least one free end of the line element being provided with a connector element (16) that has a second interior into which the inner line (14) extends, the line element according to the invention being characterized in that the support element (15) and/or the connector element (16) has at least one relief opening (25, 26) which ensures a communicating link between the first interior of the support element (15), or second interior of the connector element (16), and the environment.

### FIELD OF THE INVENTION

The invention relates to a line element for handling fluids for high-pressure and high-temperature applications with high chemical resistance, in particular for digestion or for synthesis of substances in chemical process engineering, the line element comprising at least one temperature-resistant and pressure-resistant support element that has a first interior in which an inner line made of a plastic material resistant to chemicals is arranged, at least one free end of the line element being provided with a connector element that has a second interior into which the inner line extends.

### BACKGROUND OF THE INVENTION

Line elements are known in chemical process engineering and are used, for example, for transporting a wide variety of fluids, in particular liquids, gases, solids and mixtures thereof, between storage vessels, collection vessels, reactors, cooling or heating elements, etc. These line elements can also be used for carrying out chemical or physical processes with the fluids contained in them, that is to say the line elements can also serve as reaction chambers or analysis chambers, for example in continuous-flow or stopped-flow processes. Chemical processes often involve aggressive substances, so that the line elements used in process engineering have to be resistant to the chemicals used in the respective processes. Chemical processes of this kind are also often carried out at high temperatures and/or high pressures. There is therefore a need for line elements for chemical process engineering which are resistant to a large number of aggressive substances and which can be used at temperatures of 300° C. and more and at pressures of several hundred bar.

A wide variety of line systems for carrying out analysis and synthesis processes at a laboratory scale are described in the prior art. For example, documents U.S. Pat. No. 5,215,715 and U.S. Pat. No. 5,314,664 disclose devices for carrying out chemical reactions by means of microwave heating, in which tube lines are used that are made of fluoroplastics resistant to chemicals. However, plastic tubes of this kind can be used only at very low pressures and low temperatures, well below the temperature and pressure ranges cited above.

U.S. Pat. No. 5,672,316 discloses a microwave-heatable pressure reactor into which a tube element made of a fluoroplastic extends. The interior of the reactor is pressurized by an external gas pressure supply, such that a pressure equilibrium essentially exists between the interior and the tube opening into this interior. The plastic tube system can therefore be used at temperatures of up to 260° C. and at pressures of up to 100 bar. However, the way in which the tube system is supported via the internal pressure in the reactor is complicated because of the required external gas pressure source, and it can accordingly be used only for relatively short line elements. In addition, the application of this technology is limited to processes in which the line element opens with its free end into the interior of the reactor.

European Patent EP-B-0 750 746 describes a device for handling liquids for analytical purposes, in which the lines that are used consist of platinum/iridium capillaries. However, capillaries of this kind are very expensive, and they can also be attacked by substances such as hot aqua regia or by phosphorus corrosion in the incineration of organic substances. Moreover, platinum/iridium capillaries are available only up to a length of 1.5 m. As alternatives to platinum/iridium capillaries, EP-B-0 750 746 also mentions tubes made of polytetrafluoroethylene (PTFE) that are encased by a steel cloth or a high-pressure capillary of special steel. However, in order to attach such lines to the components that are to be connected, metal flanges are used which in many applications are disadvantageous because of their limited resistance to chemicals. Moreover, there are no commercially available lines with which it is possible to obtain capillaries having small internal diameters of less than 3 mm. Moreover, when using inner lines made of fluoroplastics, substances may diffuse through the jacket of the inner tube and into the area between support jacket and inner tube at high temperatures and pressures. This can lead to a collapse of the inner tube, with the result that the tube is partly or even completely occluded.

Therefore, the technical problem addressed by the invention is that of making available a line element for handling fluids which is temperature-resistant and pressure-resistant and is also resistant to a large number of chemicals and can be produced inexpensively in large lengths. The line element according to the invention should in particular be able to be produced as a capillary line with an internal diameter of less than 3 mm.

This technical problem is solved by the line element according to Claim 1. Advantageous developments of the line element according to the invention are the subject of the dependent claims.

### SUMMARY OF THE INVENTION

The invention accordingly relates to a line element for handling fluids which is of the type described in the introduction and which is characterized in that the support element and/or the connector element has at least one relief opening which ensures a communicating link between the first interior of the support element, or second interior of the connector element), and the environment.

By way of the relief opening provided according to the invention, substances diffusing through the inner line can escape outward from the interspace between the inner line and the support element, with the result that a collapse of the inner line is effectively avoided. Any desired number and size of the relief openings can be chosen, as long as the support function of the support element is not impaired. If so required, the relief openings can also be used for flushing the support element. The line element according to the invention can be produced particularly inexpensively, even in quite considerable lengths, for example of several metres, whereas platinum/iridium capillaries are commercially available only up to a length of 1.5 m. The inner line can be formed on the inside wall of the support element by injection moulding, for example. However, it is particularly cost-effective to mechanically insert a plastic tube serving as inner line into the support element, for example by pushing the tube in, or by blowing the tube in by means of a gas or a liquid. The tube in this case has an external diameter slightly smaller than the internal diameter of the interior of the support element. On the initial application of pressure and/or temperature, the inner line then moulds itself onto the inside wall of the support element. Depending on the material used, the inner line can mould itself permanently onto the support element or can detach itself from the support element again after the pressure has lowered. In the latter case, especially if the inner line has a certain elasticity, this moulding takes place each time after application of the operating pressure. For maintenance work, for example for cleaning purposes, the inner tube can again be removed from the support element, and afterwards reinserted again, either pneumatically, hydraulically or, if appropriate, by mechanical pulling or pressing.

According to one embodiment of the invention, at least the connector element has a relief opening. Particularly in the case of fairly long line elements, one or more relief openings can also be formed in the support element.

In known plastic tube systems, a problem arises in providing the tube ends with suitable connector elements that ensure a reliable join between the connector element and the inner line under the conditions in question, in particular at temperatures of up to 300° C. and at pressures of several hundred bar. Proposed solutions involving adhesively bonded connector elements have proven disadvantageous in practice, because of the poor adherence of the fluoroplastics that are preferably used on account of their resistance to chemicals. In purely mechanical clamp connections, the problem is that, on the one hand, a firm and leaktight connection has to be ensured also at high pressures, and, on the other hand, the inner line should not be clamped shut. To solve this problem, the present invention proposes that the free end of the line element is sealed by means of at least one preferably conical clamp. A particular advantage of the solution according to the invention is that only a primary seal is needed, since, when the pressure in the system increases, the inner line is pressed more firmly onto the sealing cone and therefore remains leaktight. The mechanical fixing of the inner line is in this case provided for by the connector element in conjunction with the mechanically securely connected support element serving as support jacket, via static friction between inner line and the support element. In addition, a light clamping can be provided. The inner line is thus held securely even at very high pressures and upon heating of the system, without any danger of constriction by a sealing and retaining cone. The mechanical fixing of the support element in the connector element can be effected for example by clamping sleeves, threads or adhesive bonds.

According to a first variant, the connector element has a connector piece which can interact with complementary connector bushings provided on the components to which the line element according to the invention is to be attached. For example, the connector piece can be designed as a screwed connection with a conical sealing surface which can interact with a complementary sealing surface of a component that is to be connected to the line element. According to one embodiment of the invention, the inner line extends into the connector piece and, when screwed into the corresponding mating piece, is compressed such that the connector piece is sealed against the inner line only upon screwing.

According to a second variant, the support element comprises at least two support tube portions which are connected releasably to one another via a connector element designed as joining element. Here too, the mechanical fixing of the support element in the connector element can be effected via clamping sleeves, threads or adhesive bonds.

In both variants, the construction of the connector element ensures that the tube cannot emerge from the connector piece at high pressures or be squeezed together by liquid that diffuses out.

The inventive design of the connector elements permits a considerable lengthening of the working life of the line element. If the line has to be made shorter, for example because of ageing or soiling in the connector pieces, it is not necessary to exchange the entire line element. After dismantling of the support line, all that needs to be done is to cut off the soiled end portion of the line element. A shorter support tube or the shortened support tube is then fitted over the old inner line.

According to an advantageous embodiment of the line element according to the invention, the inner line is made of a fluoroplastic resistant to chemicals, for example of polytetrafluoroethylene (PTFE), polytetrafluoroethylene compounds, that is to say PTFE with suitable fillers such as glass fibres, charcoal, bronze, molybdenum disulphide or special steel, perfluoroalkoxy copolymers (PFA), polychloro-trifluoroethylene or polyvinylidene fluoride. In addition, however, the inner line can also be made of high-performance plastics such as polyether ether ketone (PEEK), polyoxymethylene or polyamide.

Advantageously, the support element comprises a support tube which surrounds the inner line and which is preferably made of metal, for example titanium or special steel, a ceramic material or a temperature-resistant and pressure-resistant plastic, for example polyether ether ketone. The support tube can in particular be designed as a flexible metal wire mesh or metal wire cloth. Particularly as a wire mesh, the support tube can be designed such that, on the one hand, the necessary support function is ensured and, on the other hand, the mesh already provides the required relief openings for release of the substances diffused through the inner line.

The support element can also comprise a support body which surrounds the inner line and which is made of a cured or dried moulding compound. The production of the support body by means of a curing or drying moulding compound permits particularly good flexibility in the shaping of the support body. The support element can also be made up of two or more solid elements which form a hollow space for receiving the inner tube and which are resistant, at least for a certain duration, to the reagents that are used. Optionally, the support body or the multi-part support element can also be surrounded by a housing, preferably a metal or plastic housing, which further increases the stability of the arrangement.

The internal diameter of the inner line of the line element according to the invention preferably lies in the range of 0.5 to 5 mm, and particularly preferably in the range of 1 to 3 mm.

The line element according to the invention can also be temperature-controlled. For example, the support element can be heated by electric resistance heating or by inductive or resistive heating to temperatures of over 300° C. By mounting Peltier elements in or on the support element, the latter can also be cooled to temperatures far below 0° C. Of course, it is also possible to lead the line element through a temperature-control medium which is heated or cooled to the desired temperature via a secondary circuit.

In addition to its use purely for transporting substances, the line element according to the invention can also be used as a reactor for chemical or physical processes. The invention accordingly also relates to the use of the described line element for physical and/or chemical treating or influencing of fluids contained in the inner line of the line element. The corresponding physical and/or chemical processes can be realized, for example, as continuous-flow processes or as stopped-flow processes. For example, the line element according to the invention or segments of several line elements according to the invention can be divided into zones in which energy is delivered or removed, for example by cooling, heating or irradiating. The line system according to the invention can also be used for mixing and, if appropriate, subsequent reaction of different substances, and the materials involved can also be present in different states of aggregation. Typical areas of application of the line element according to the invention also lie in chemical analysis, for example continuous-flow digestion, high-pressure chromatography or gas chromatography.

### BRIEF DESCRIPTION OF THE DRAWINGS

The invention is explained in more detail below with reference to the illustrative embodiments depicted in the attached drawings, in which:

FIG. 1 shows a schematic representation of an analysis device in which a first embodiment of the line element according to the invention serves as a connecting line between two components of the device;

FIG. 2 shows a detailed view of one end of the line element from FIG. 1, with a connector element for connection to one of the components of the device;

FIG. 3 shows a further embodiment of the line element from FIGS. 1 and 2 with a modified support element;

FIG. 4 shows a modified embodiment of the line element from FIG. 3 with a further variant of the support element;

FIG. 5 shows a further embodiment of the line element according to the invention from FIG. 2, in which a connector element is designed for attachment to a second line element; and

FIG. 6 shows an example of a device for chemical reaction in which the individual segments of the device are connected by line elements according to the invention.

### DETAILED DESCRIPTION OF THE INVENTION

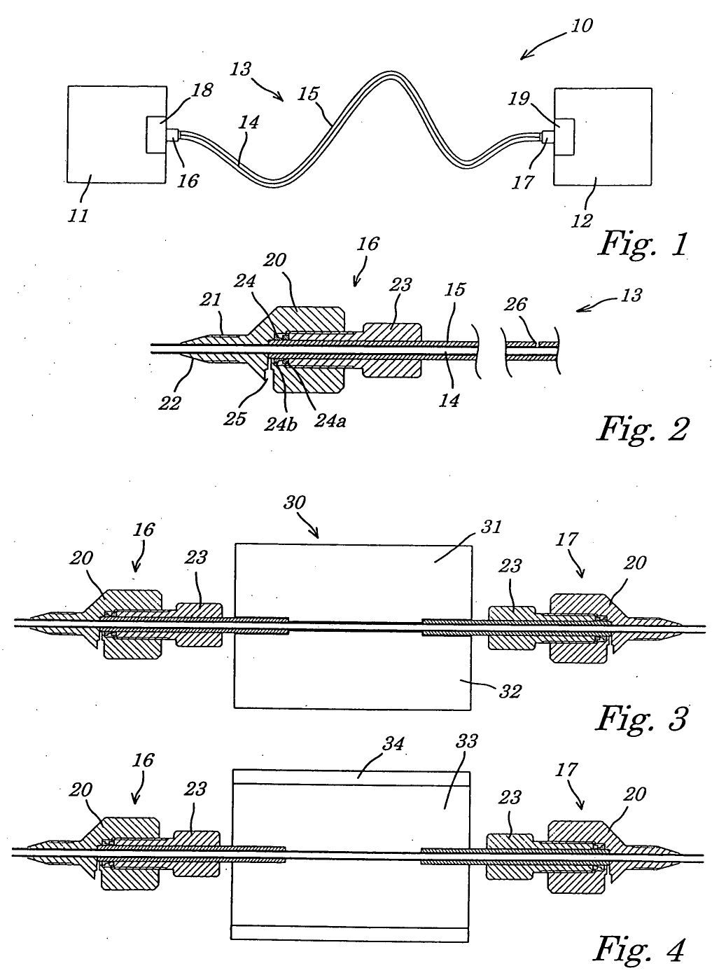

FIG. 1 is a schematic representation of a device intended to serve as an example of the use of the line element according to the invention as a connecting line between two components of the device. The device, designated overall by reference number 10, is made up of a first component 11, which for example can be a sample source or a device for preparing a sample, and of a second component 12, which for example can be a detection means, for instance a gas chromatograph. The two components 11, 12 are connected to one another via a line element according to the invention, designated overall by reference number 13, so that fluids can be transferred from component 11 to component 12. The line element 13 according to the invention comprises an inner line 14, which is indicated only schematically in FIG. 1 and which is made, for example, of a fluoroplastic such as polytetrafluoroethylene and is surrounded by a temperature-resistant and pressure-resistant support tube 15. In the example in FIG. 1, both the inner line 14 and the support tube 15 are flexible. The support tube 15 can, for example, be configured as a metal wire mesh. However, the support tube 15 can also be a rigid tube, for example a tube made of special steel or titanium. At its two ends, the line element 13 according to the invention has connector elements 16, 17 for connecting the line element 13 to corresponding connector bushings 18, 19 provided on the components 11, 12.

The left-hand end of the connecting line 13 from FIG. 1, with the connector element 16, is shown in greater detail in FIG. 2. For the sake of clarity, the connector element 16 in FIG. 2 is shown in the free state in which it is therefore not located in the corresponding connector bushing 18 of the component 11 from FIG. 1. In the example shown, the connector element 16 is in several parts and is made up of a connector 20, which is shaped such that it can be fitted tightly into the corresponding connector bushing 18 (cf. FIG. 1) of the component that is to be connected. The connector elements 16, 17 according to the invention have a cylindrical thread area 21 and a cone-shaped end area 22. The cone 22 of the connector 20 is pressed together when screwed into the part 18 and forms a seal against the polytetrafluoroethylene tube 14. When high pressures arise in conventional connectors, there is a danger of the tube slipping out of the connector; this can no longer be compensated for by tightening the connector, because otherwise the tube would be squeezed off in the area of the cone. In the connector element 16 according to the invention, however, static friction of the inner tube 14 in the connector 20 and in the support tube 15 is able to prevent it from slipping axially out of the sealing cone 22. For this purpose, the support tube 15 is fixed securely in the connector 20 by means of a clamping ring 24 and the hollow screw 23. The clamping ring consists of a metal ring 24a and of a sealing cone 24b. Upon assembly, the hollow screw 23 presses the metal ring 24a onto the sealing cone 24b and the latter is thereby squeezed permanently onto the support tube 15. However, because of the mechanical stability of the support tube 15, there is no appreciable constricting of the tube 15 and of the inner tube 14 extending therein. The static friction resulting from the inner tube 14 moulding onto the support tube 15, which is also no longer movable after the clamping, avoids any slipping movement of the inner tube relative to the support tube. All of the components of the connector element 16 can be produced free of metal, for example from polyether ether ketone (PEEK). The clamping ring 24 in particular can also be made of metal, for example titanium, or, since the clamping ring does not come into contact with aggressive substances, of special steel. A relief opening 25, which is designed as a drainage bore in the example shown, is formed in the connector element according to the invention. Substances diffusing through the PTFE tube 14 can escape outwards through the relief opening 25 into the environment, with the result that no overpressure arises between the inner tube 14 and the support tube 15, which overpressure would otherwise lead to collapse of the inner tube 14. For longer line elements, as shown schematically in FIG. 2, further relief openings 26 can also be provided in the support tube 15.

FIG. 3 shows a variant of the line element according to the invention in which the support element consists of a mechanically stable support body 30, at least in a partial area of the line. In the example in FIG. 3, the support body consists of two connectable parts 31, 32, but it can also comprise more than two parts. Such support bodies can be used in a wide variety of ways to physically influence the fluids transported in the inner tube 14. For example, the support body 30 can serve as a heat exchanger for controlling the temperature of the transported fluids. For this purpose, the support body itself can be temperature-controlled via a heat exchange medium, for example water, circulating in a secondary circuit (not shown). In the case of metal support bodies, it is also possible to heat the support body by inductive or resistive direct heating or to cool it via Peltier elements integrated into the support structure or secured on its outside surface. If the fluids transported in the inner tube 14 are to be heated via microwave heating (also not shown), the support body is preferably made of a microwave-transparent material, for example a plastic or ceramic material. However, in the case of microwave heating, the support body 30 can also contain microwave-absorbing substances, for example soot particles, such that the whole support body serves as a heating bath.

FIG. 4 shows a variant of the support body 30 from FIG. 3. The support body 33 shown in FIG. 4 is made in one piece and is shaped from a curing casting compound. Depending on the pressure that the support body has to withstand, it can additionally be provided with a housing 34 that increases the stability of the support body.

Also in the variants shown in FIGS. 3 and 4 with support body, a part of the support element is advantageously designed as a support tube 15 protruding out of the support body 30 or 33, its ends again being provided with the connector elements 16, 17 already mentioned in connection with FIGS. 1 and 2.

FIG. 5 shows a variant of the line element from FIG. 2 in which one end of the line element 13 is provided with the connector element 16 already described in FIG. 2. In this variant, the support tube 15 consists of a first support tube 15a and of a second support tube 15b which are connected to one another by a connector element 40. The connector element 40 is designed as a cylindrical connector 41, into whose end openings 42, 43 the ends of the support tubes 15a and 15b, respectively, extend. The two ends of the support tubes 15a and 15b are once again fixed in the cylindrical connector 41 by hollow screws 23 and two-part clamping rings 24. Like the conical connector 20, the cylindrical connector 41 can also have a relief opening 27. In the cylindrical connector 41, the two support tubes abut one another in the contact area 44. The contact area 44 should as far as possible be gap-free in order not to impair the support action. In this area, however, no sealing of the inner tube 14 is needed. Usually, a slight leakage is even desired in order to ensure a pressure relief of the diffusing substances.

If the inner tube 14 were to become blocked at its end area 45 as a result of soiling or mechanical defects, it is possible, in the variant in FIG. 5, to cut the tube end 45 off to the required length and either to shorten the support tube 15b too or replace it by a shorter support tube 15c. The line element 13 can thus continue to be used. In the event of blockage of the inner line, it is therefore not necessary to dispose of the entire line element 13.

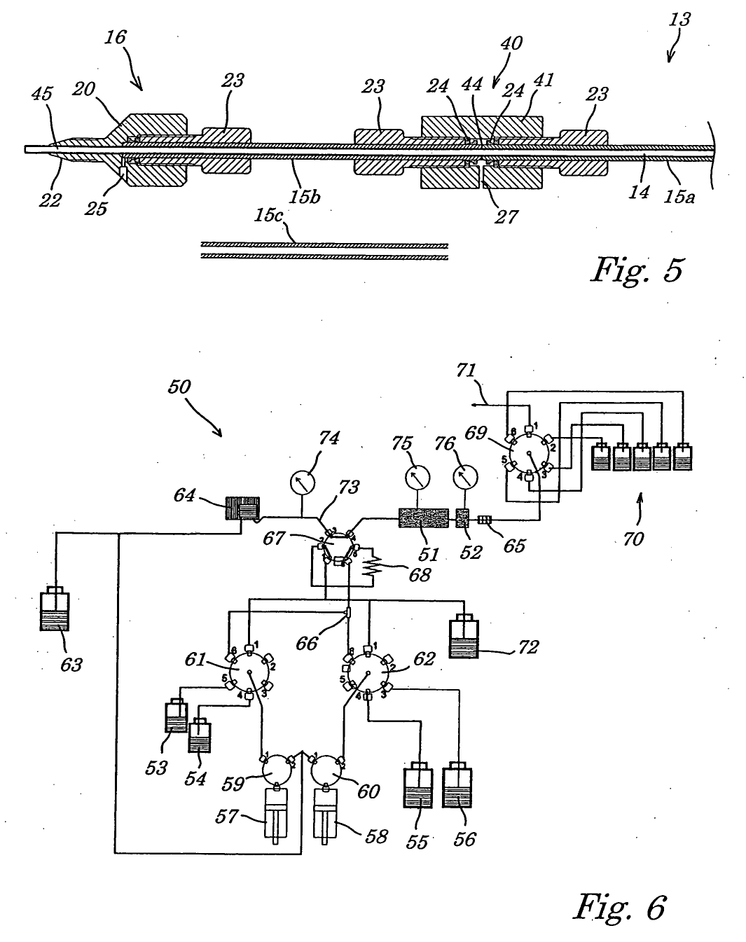

FIG. 6 shows a device 50 for carrying out high-temperature and high-pressure reactions in which use is made of line elements according to the invention which, in the device shown, are used as reactor 51 and cooler 52 in order to carry out reactions with different starting materials 53, 54 with different substances (here a first acid 55 and a second acid 56).

The reactor 51 and the cooler 52 can, for example, be designed in accordance with the variants shown in FIGS. 3 and 4 and can be provided with the heating or cooling means explained in connection with FIGS. 3 and 4.

The device 50 works as follows: To prepare for the reactions, pumps 57, 58 and multi-way valves 59, 60, 61, 62 fill all the lines of the system with a carrier liquid 63, which at the same time can also be reagent or substrate. At the same time an HPLC pump 64 builds up the system pressure in the reactor 51 and in the cooler 52 counter to the resistance of the restrictor 65. The restrictor 65 can either be a thin capillary or a pressure control valve. After the system pressure has been built up, the reactor 51 is heated to the desired operating temperature. As soon as the operating temperature is reached, the pump 57 suctions one or more starting materials 53, 54 via the valves 59 and 61, while the pump 58 suctions one or more reagents 55, 56 via the valves 60 and 62. The starting materials and the reagents are then metered through a T-piece 66 and valve 67 into a sample loop 68 and mixed. Alternatively, the sample loop 68 can be filled directly in the bypass from a process or by any desired other filling method. The valve 67 is then switched so that the content of the sample loop 68 can be introduced into the reaction system 51, 52. After the fluids have been heated and the desired reactions have been carried out in the reactor 51, and after subsequent cooling in the cooler 52, the end product can be collected via a controllable valve 69 into different vessels 70 or can be delivered directly to a measurement device (not shown), for example via a line 71 branching off from the valve.

FIG. 6 also shows a collecting vessel 72 in which, before and after the filling of the sample loop 68, irrigation liquids for cleaning the lines and/or sample and reagent solutions can be collected during filling of the lines. A pressure gauge 74 is also shown with which the pressure in the line 73 between HPLC pump 64 and restrictor 65 can be monitored. The temperature in the reactor 51 and in the cooler 52 is monitored by means of temperature probes 75, 76.

Several high-pressure reaction systems of this kind can be arranged in parallel or in series, in order to increase the throughput or to execute different treatment steps one after another.

Having described the invention, the following is claimed:

1. Line element for handling fluids, comprising at least one temperature-resistant and pressure-resistant support element having a first interior in which an inner line made of a plastic material resistant to chemicals is arranged, at least one free end of the line element being provided with a connector element having a second interior into which said inner line extends, wherein said support element and/or said connector element have at least one relief opening which ensures a communicating link between said first interior of said support element or said second interior of said connector element and the environment.

2. Line element according to claim 1, wherein at least said connector element has a relief opening.

3. Line element according to claim 1, wherein said connector element comprises at least a first clamp for sealing said free end of said line element.

4. Line element according to claim 3, wherein said first clamp is designed as a connector piece.

5. Line element according to claim 4, wherein said connector piece has a conical sealing surface which is adapted to interact with a complementary sealing surface of a component part that is to be connected to the line element.

6. Line element according to claim 3, wherein said support element comprises at least two support tube portions which are connected releasably to one another via a connector element designed as joining element.

7. Line element according to claim 1, wherein said inner line is made of a fluoroplastic material.

8. Line element according to claim 7, wherein said fluoroplastic material is selected from the group comprising polytetrafluoroethylene, polytetrafluoroethylene compounds, perfluoroalkoxy copolymers, polychlorotrifluoroethylene and polyvinylidene fluoride.

9. Line element according to claim 1, wherein said support element comprises a support tube which surrounds said inner line and which is made of a material selected from metal, ceramic or a temperature-resistant and pressure-resistant plastic.

10. Line element according to claim 9, wherein said support tube is made of titanium, special steel or polyether ether ketone.

11. Line element according to claim 10, wherein said support tube is made of a flexible metal wire mesh or metal wire cloth.

12. Line element according to claims 1, wherein said support element comprises a support body which surrounds said inner line and which is made of a cured or dried moulding compound.

13. Line element according to claim 12, wherein said support body is surrounded by a housing, preferably a metal or plastic housing.

14. Line element according to claims 1, wherein said inner liner has an internal diameter in the range of 0.5 to 5 mm, preferably in the range of 1 to 3 mm.

15. Line element according to claim 1, wherein said line element is temperature-controllable.

16. A method for physical and/or chemical treating a fluid, wherein said fluid is passed through a line element comprising at least one temperature-resistant and pressure-resistant support element having a first interior in which an inner line made of a plastic material resistant to chemicals is arranged, at least one free end of the line element being provided with a connector element having a second interior into which said inner line extends, wherein said support element and/or said connector element have at least one relief opening which ensures a communicating link between said first interior of said support element or said second interior of said connector element and the environment.

17. The method of claim 16, where said fluid is treated in a continuous-flow process or in a stopped-flow process.
